(19) United States
(12) Patent Application Publication
(10) Pub. No.: US 2006/0221632 A1
(43) Pub. Date: Oct. 5, 2006

(54) Signboard using LED light source

(76) Inventor: Yu-Ching Hsu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/094,103

(22) Filed: Mar. 31, 2005

(51) Int. Cl. F21V 7/04

(52) U.S. Cl. 362/604; 362/612; 362/632; 362/812

(57) ABSTRACT

A signboard comprises a frame having its front side mounted with a panel, a reflector behind the panel with a distance therebetween, LED lamps arranged at one or more sides of the frame, and a light guide plate close to the LED lamps to guide the light emitted by the LED lamps from the LED lamps to the panel and to the reflector. Preferably, the frame includes reversible part or movable part to expose the LED lamps. Preferably, the LED lamps are packaged in a module. Preferably, one or more scattering plates are further introduced behind the panel to improve the illumination.

### FIELD OF THE INVENTION

The present invention is related generally to a signboard and more particularly, to a signboard using LED light source.

### BACKGROUND OF THE INVENTION

Signboards are widely used, for example as emergency exit indications in buildings or at public places, and the other applications include indications of positions and service items.

A typical signboard comprises a light box that contains fluorescent lamps to project light on the panel with patterns and/or words at the front side of the light box for indication. One disadvantage of using fluorescent lamps in light box is the bases and the wires of the fluorescent lamps easily to drop, and for this, the signboard in Taiwanese Patent Application No. 090211315 proposed a clip cover to fix the lamp tubes and a slot to retain the wires. While the fluorescent lamps and their accessories occupy much space and thus result in the large size of the light box, the signboard in Taiwanese Patent Application No. 087206192 uses electro-luminescent (EL) sheet instead as the light source. However, EL sheet is low illuminative and is thus not practical. Another disadvantage of using fluorescent lamps in signboard is their high power consumption. A signboard usually needs two fluorescent lamps for enough luminance and therefore consumes much power. In addition, due to the high power consumption, the backup power source is used up quickly after the normal power is off. Using only one fluorescent lamp can reduce the power consumption, but the illumination is not enough, and the patterns or words on the panel more far away from the fluorescent lamps become vague.

Light emitting diode (LED) has the advantages of low power consumption, longer lifetime, no warm-up time, fast response and small size, and therefore has been widely used on traffic signs, show boards, car lights and illuminations. However, there are still some difficulties for using LED lamps on signboards. In Taiwanese Patent Application No. 085219088, the signboard has LED lamps surrounding the patterns on the panel to enhance the indication. Though the patterns on the panel become vibrant, the structure of the signboard is too complicated. The signboard in Taiwanese Patent Application No. 092218016 uses LED lamps to replace fluorescent lamps behind the panel for power reduction, but the illumination on the panel becomes non-uniform seriously. Specifically, an LED lamp behaves like a point light source, and therefore the area on the panel directly facing the LED lamps is harsh to the eyes, while the other area on the panel is too dark to identify the patters or words. LED lamps are also used in the backlight module of liquid crystal display (LCD). While the light guide plate and the diffusion plate in the backlight module take up the most space of the backside of the whole display, and such huge volume, heavy weight and low light efficiency make it unsuitable to use in signboards.

It is therefore desired a signboard of power saving and high and uniform illumination.

### SUMMARY OF THE INVENTION

One object of the present invention is to provide a signboard using LED light source.

In a signboard using LED light source, according to the present invention, a frame has its front side mounted with a panel thereon, a reflector is positioned behind the panel with a distance therebetween, a plurality of LED lamps are arranged at one or more sides of the frame, and a light guide plate is positioned close to the LED lamps to guide the light emitted from the LED lamps to the panel and to the reflector.

In one embodiment, the frame includes as least one reversible part to expose the LED lamps, and preferably, the LED lamps are mounted on the reversible part.

In another embodiment, the frame includes at least one movable part to expose the LED lamps. Preferably, the LED lamps are mounted on the movable part, and therefore the LED lamps are removed from the frame when the movable part is extracted from the frame.

In yet another embodiment, the frame includes a first part and second part combined together. The panel and the light guide plate are mounted on the first part, and the LED lamps are mounted on the second part.

Preferably, the light guide plate has a groove aligned to the LED lamps.

Preferably, the signboard further comprises a diffusion plate inserted between the light guide plate and the LED lamps.

Preferably, the signboard further comprises at least one scattering plate behind the panel for scattering the light emitted from the LED lamps to the panel.

In one embodiment, the LED lamps are packaged in a module, and the module has at least two pins for electrical connection.

In another embodiment, the LED lamps are individually mounted on a printed circuit board.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a decomposition diagram of a first embodiment according to the present invention;

FIGS. 2A to 2D show perspective diagrams of several light guide plates;

FIGS. 2E to 2H show perspective diagrams of several combinations of light guide plate and diffusion plate;

FIGS. 3A to 3D provide several panels with different patterns and/or words thereon;

FIGS. 4A and 4B show combination diagrams of the signboard shown in FIG. 1;

FIGS. 4C and 4D show cross-sectional views of the signboard shown in FIG. 1;

FIGS. 5A to 5D show several types of module LED lamps;

FIG. 6 shows a cross-sectional view of a second embodiment according to the present invention;

FIG. 7 shows a decomposition diagram of a third embodiment according to the present invention;

FIG. 8 show a combination diagram of the signboard shown in FIG. 7; and

FIG. 9 shows a cross-sectional view of a forth embodiment according to the present invention.

### DETAILED DESCRIPTION OF THE INVENTION

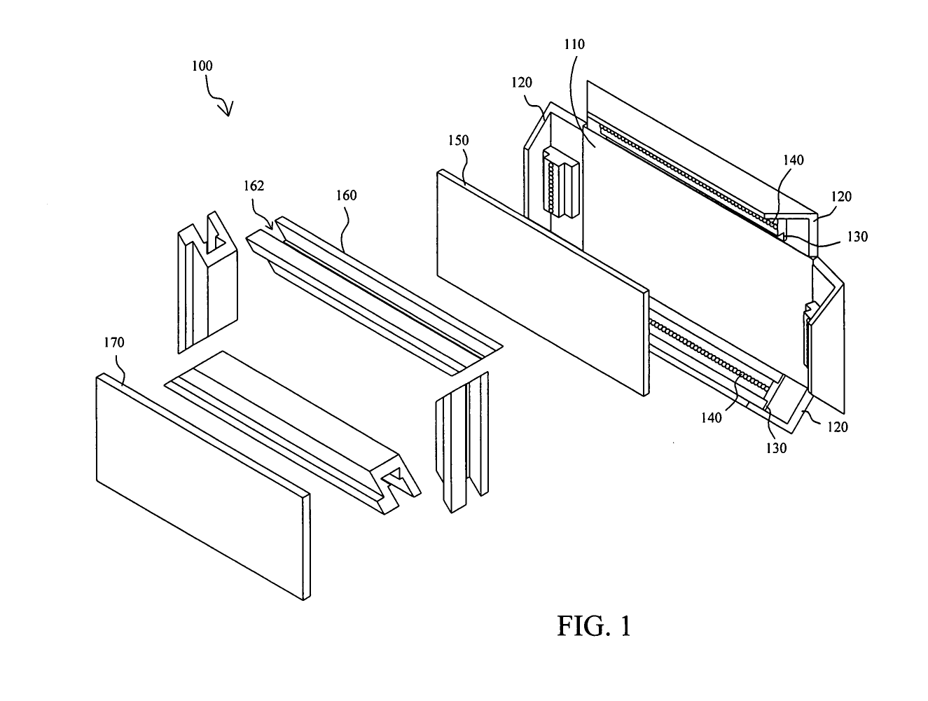

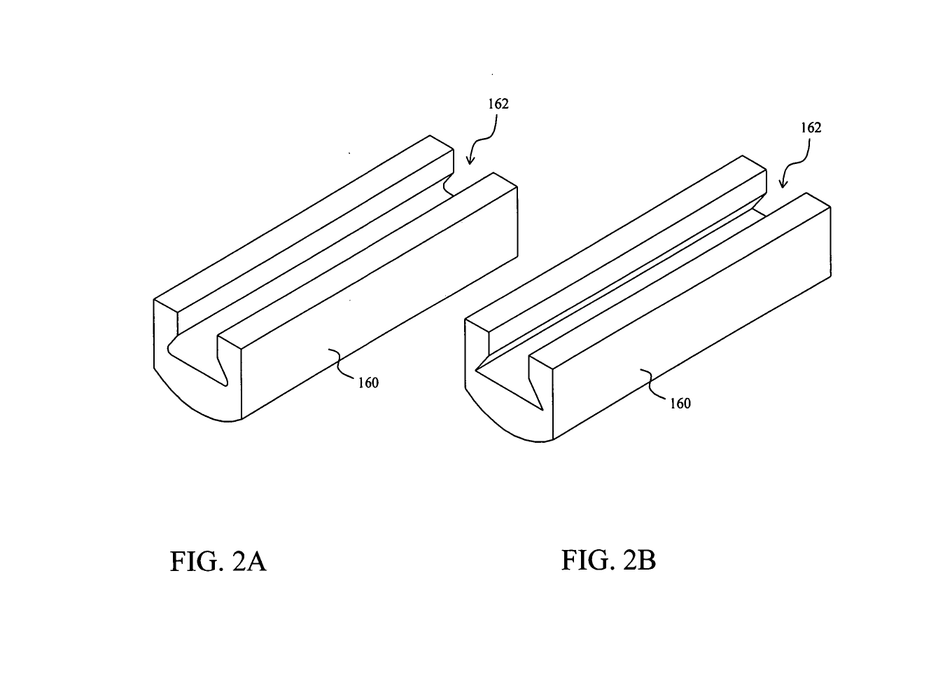

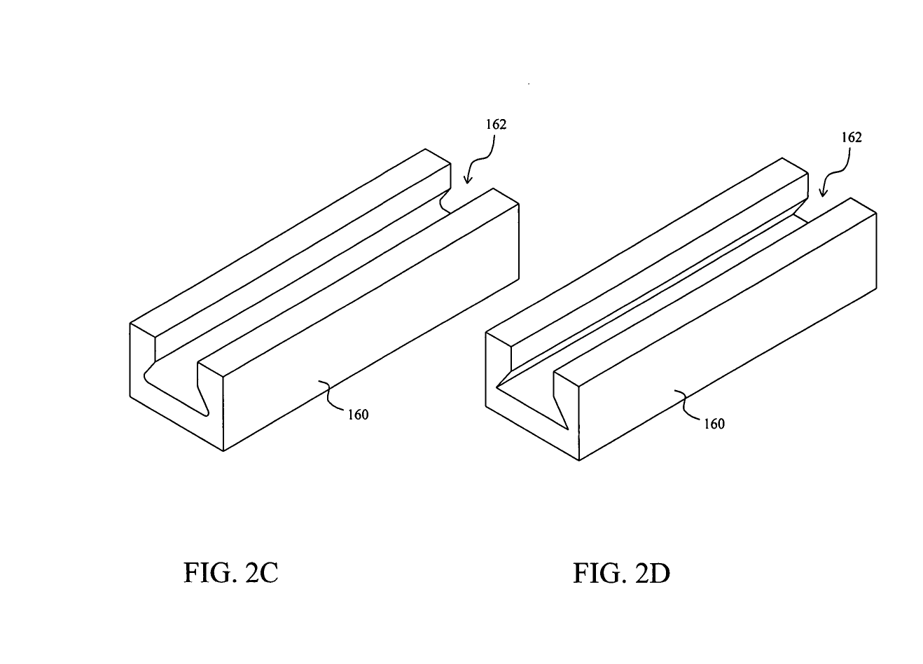

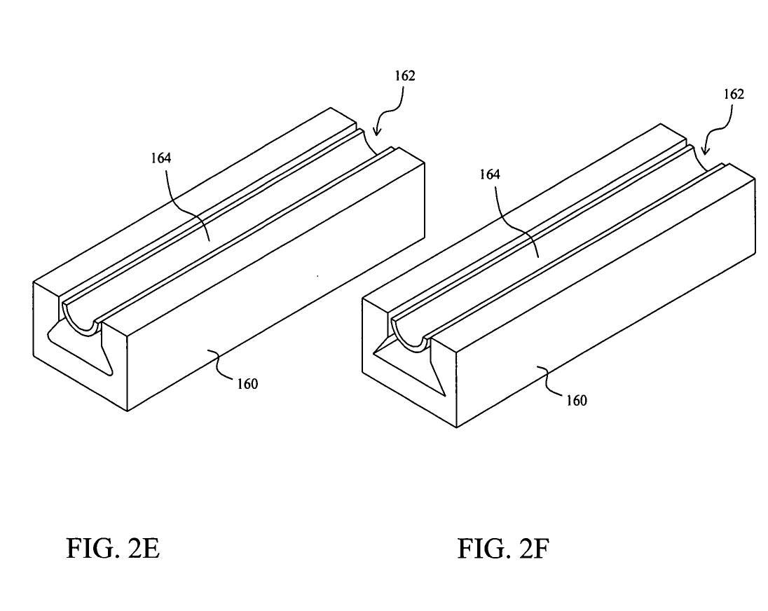

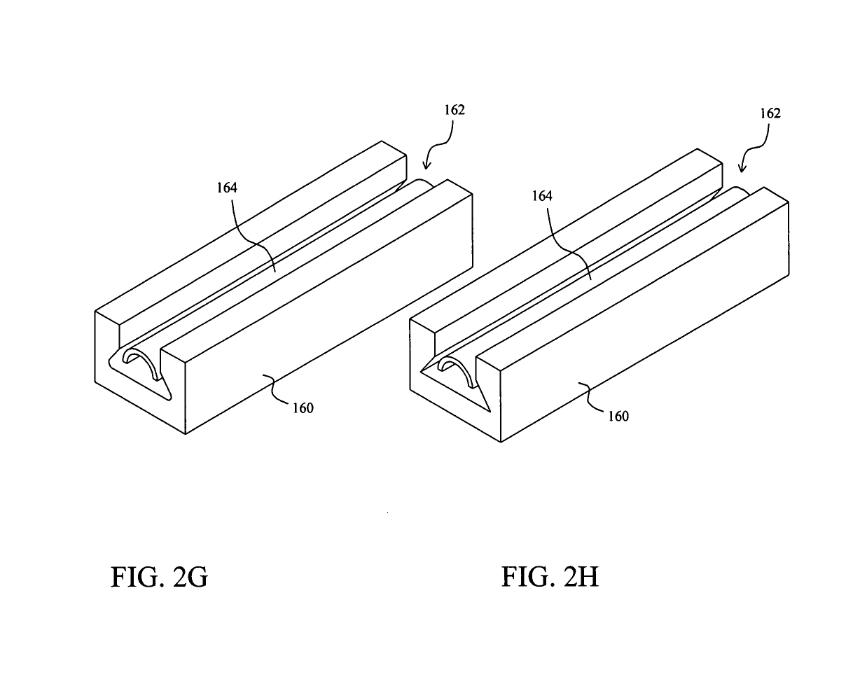

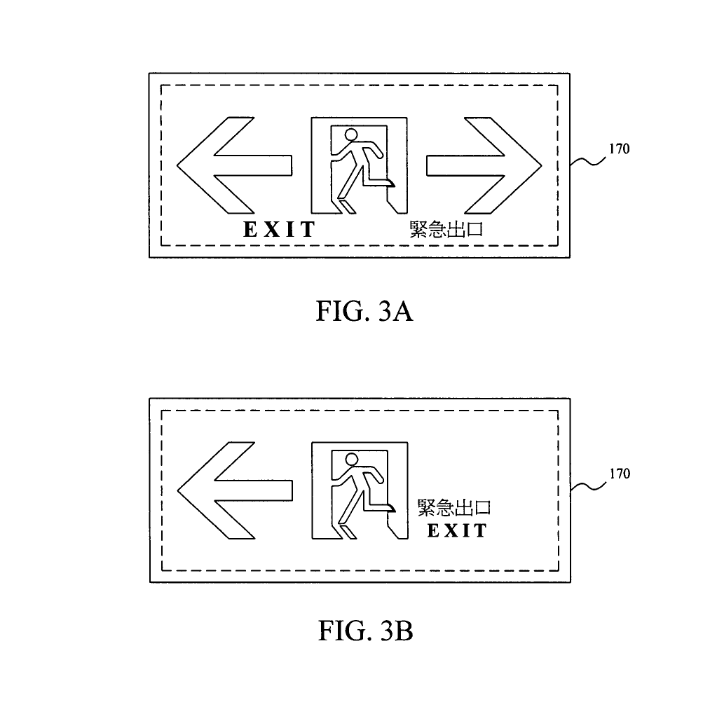

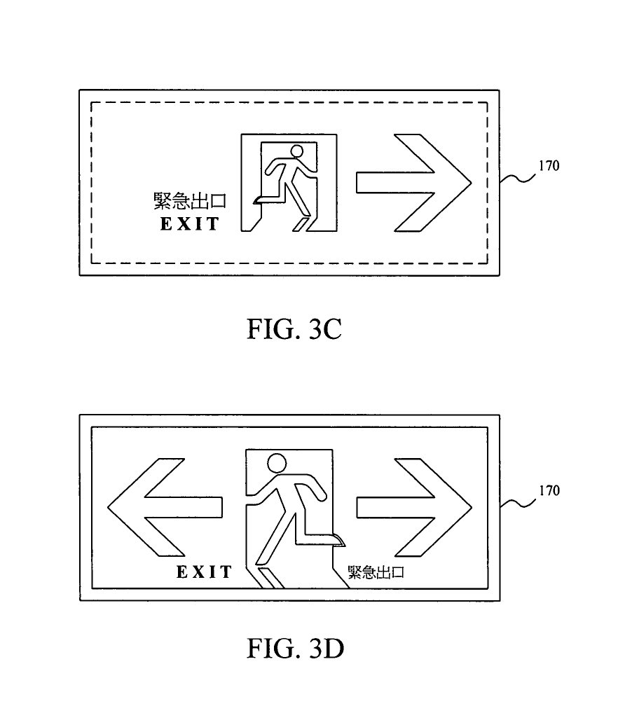

FIG. 1 shows a decomposition diagram of a first embodiment according to the present invention. In a signboard 100, a frame 110 made of for example aluminum (Al) or other materials includes four reversible parts 120 each at one side of the frame 110, and preferably the reversible part 120 has one or more base 130 fixed thereon to mount several LED lamps 140 arranged to face to a light guide plate 160. The light guide plate 160 preferably has a groove 162 aligned to the LED lamps 140. In various embodiments, the light guide plate 160 may have different shape and groove 162, for example shown in FIGS. 2A to 2D. Preferably, a diffusion plate 164 may be inserted additionally between the light guide plate 160 and the LED lamps 140, as shown in FIGS. 2E to 2H. The light guide plate 160 is made of acrylic or other transparent materials. On the front side of the frame 110, a panel 170 is mounted, on which patterns and/or words printed or attached, for example shown in FIGS. 3A to 3D. The panel 170 is made of tempered glass. Behind the panel 170, it is placed a reflector 150 such as an aluminum plate coated with highly reflective film. In other embodiments, the reflector 150 may be a reflective surface on the frame 110 behind the panel 170.

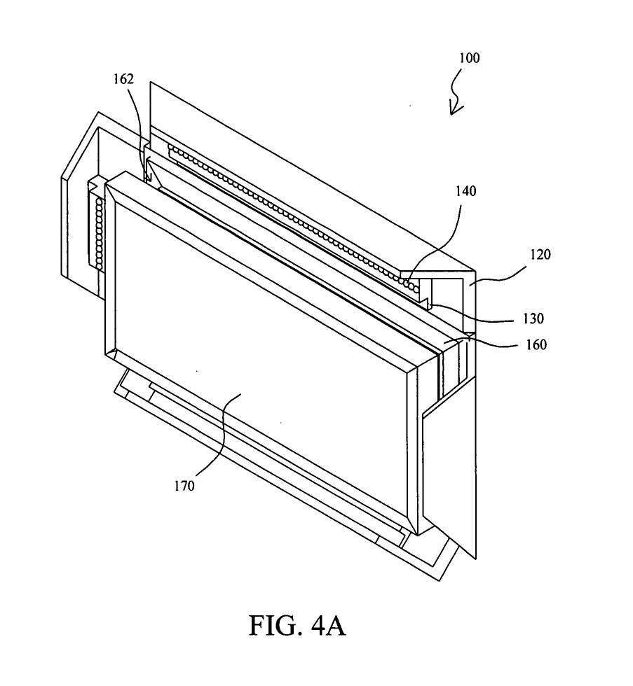

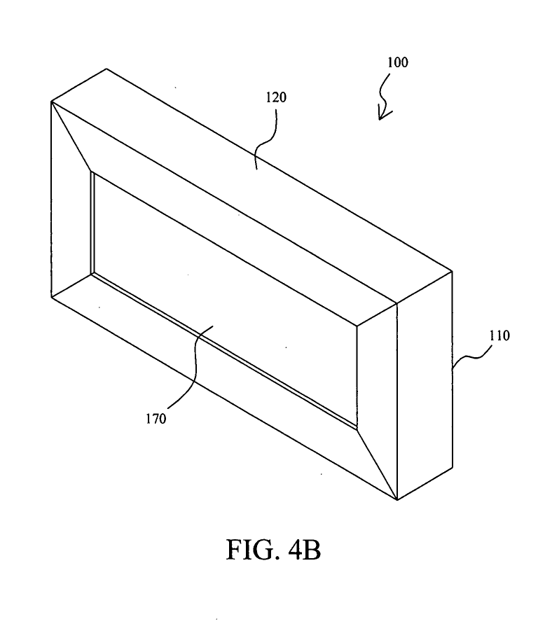

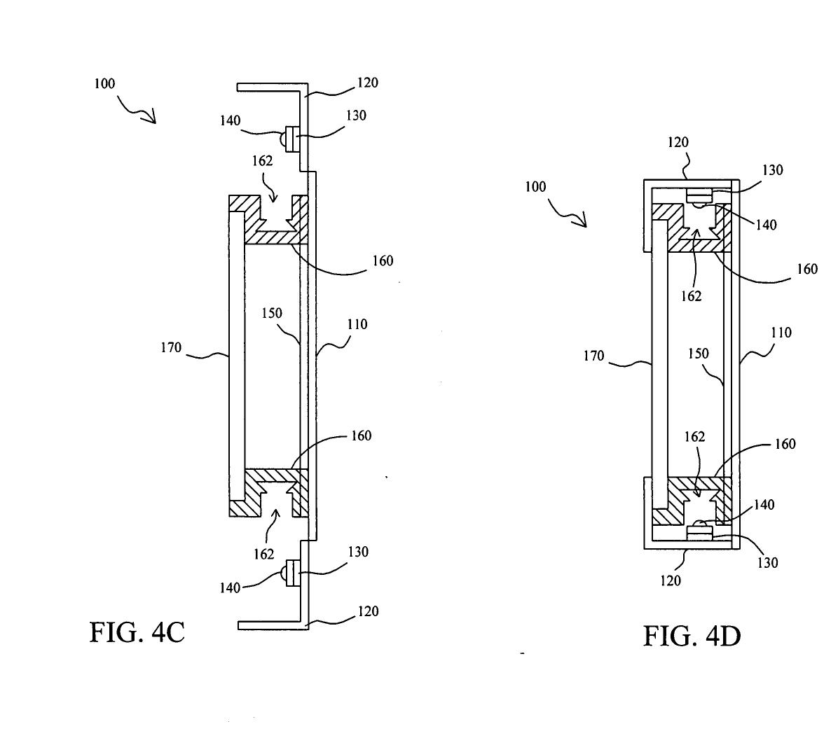

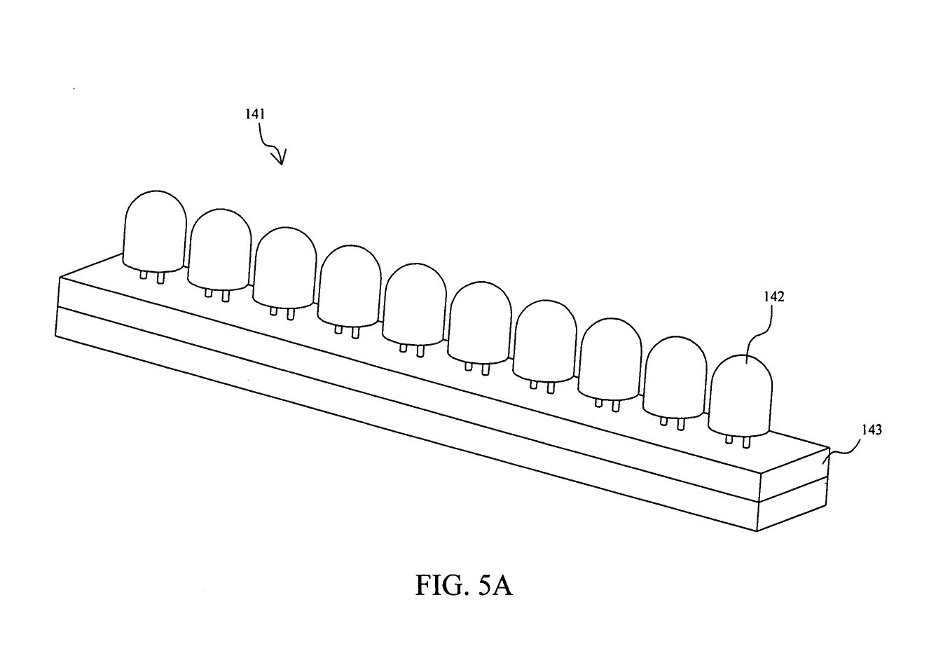

FIGS. 4A and 4B show combination diagrams of the signboard 100, and FIGS. 4C and 4D show its cross-sectional views. When the reversible part 120 of the frame 110 is flipped, the LED lamps 140 are exposed, and it is therefore convenient to maintain or replace the LED lamps 140. When the reversible part 120 is flopped, the LED lamps 140 are aligned to the light guide plate 160, such that the light guide plate 160 guides the light emitted from the LED lamps 140 to the panel 170 and the reflector 150. Since the LED lamps 140 do not directly face the panel 170, there will be no local light spots generated on the panel 170. Furthermore, the light emitted by the LED lamps 140 propagates through the light guide plate 160 to the panel 170 or is reflected from the reflector 150 to the panel 170, resulting in uniform illumination on the panel 170. Preferably, the LED lamps 140 extend into the groove 162 of the light guide plate 160, while in other embodiments the LED lamps 140 are outside the groove 162. Due to the tiny size of the LED lamps 140, the signboard 100 is compact and its thickness is thin. In addition, the light guide plate 160 is a narrow stripe hidden at the side of the signboard 100, and thus no space behind the panel 170 is occupied. As a result, small and compact volume, light weight, and less light loss and power consumption are achieved. The tiny structure for light scattering generally manufactured on the optical element such as the backlight plate in LCD module is not necessary hereof, and thus the cost of material and fabrication for the signboard 100 is dramatically reduced.

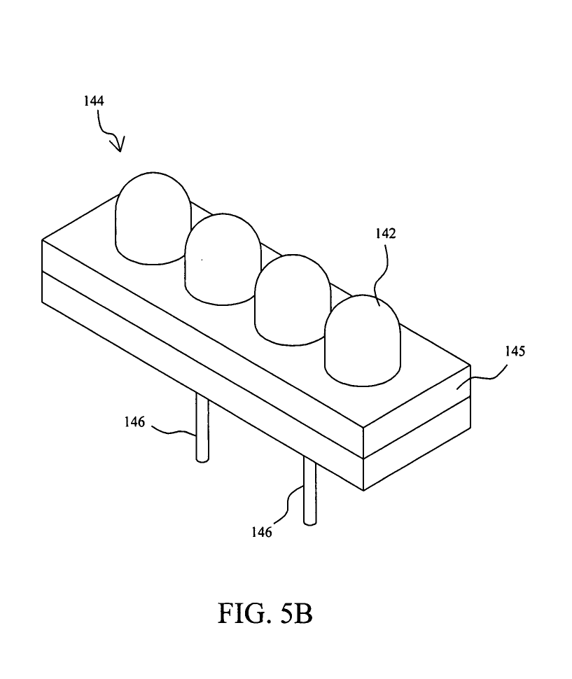

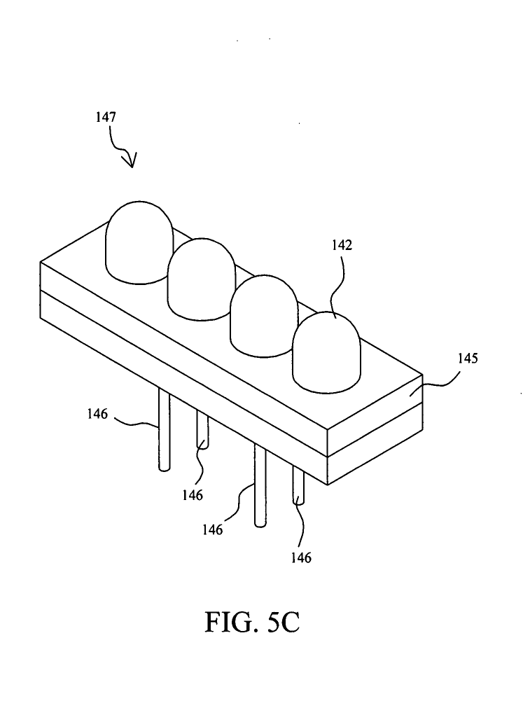

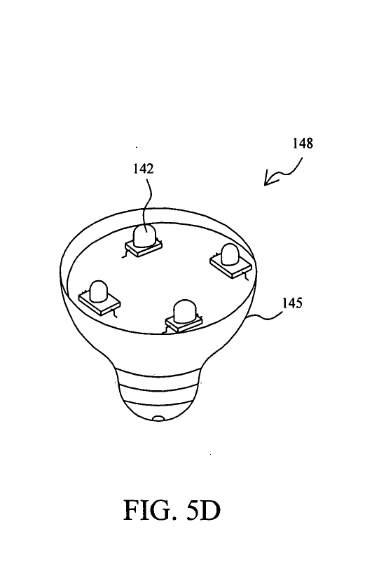

Various types of LED lamps may be applicable for the signboard 100. As shown in FIG. 5A, for example, the LED lamps 141 include several LED lamps 142 individually welded on a printed circuit board 143, and the printed circuit board 143 is then fixed on the base 130 of the signboard 100. The LED lamps can also be packaged to be a module. For example, the LED lamps 144 shown in FIG. 5B include several LED lamps 142 packaged in a module, and the lamp base 145 of the module has two pins 146 to insert into the base 130 for electrical connection. FIG. 5C shows a different package of LED lamps 147, which module has four pins 146 extended from the lamp base 145 thereof. FIG. 5D shows yet another module of LED lamps 148 packaged with different LED lamps 142 and lamp base 145. By using the module LED lamps 144, 147 or 148 for the LED lamps 140 of the signboard 100, it is more convenient to mount and replace the LED lamps 140 for the signboard 100, just the same as to mount and replace a conventional light bulb.

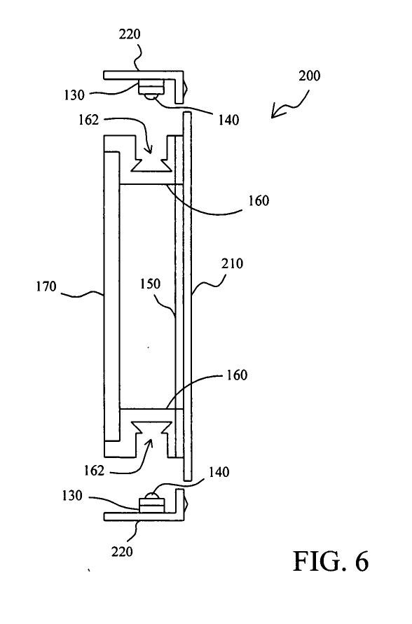

FIG. 6 shows a cross-sectional view of a second embodiment according to the present invention. In a signboard 200, a frame 210 includes a movable part 220 such as a cassette, and the other components of the signboard 200 are the same as those of the signboard 100. The movable part 220 could be extracted from the frame 210 to expose the LED lamps 140. Preferably, the LED lamps 140 are mounted on the movable part 220 by the base 130 and therefore, after the movable part 220 is extracted from the frame 210, the LED lamps 140 are removed from the frame 210 and could be taken away together with the movable part 220 from the field for more convenient work such as test, maintenance and replacement of the LED lamps 140. The LED lamps 140 and the movable part 220 may be further modulated, and therefore replacement of the LED lamps 140 can be easily achieved by replacing a module. In this embodiment, the LED lamps 140 can be positioned deeply into the groove 162 of the light guide 160, and the groove 162 can be shallower.

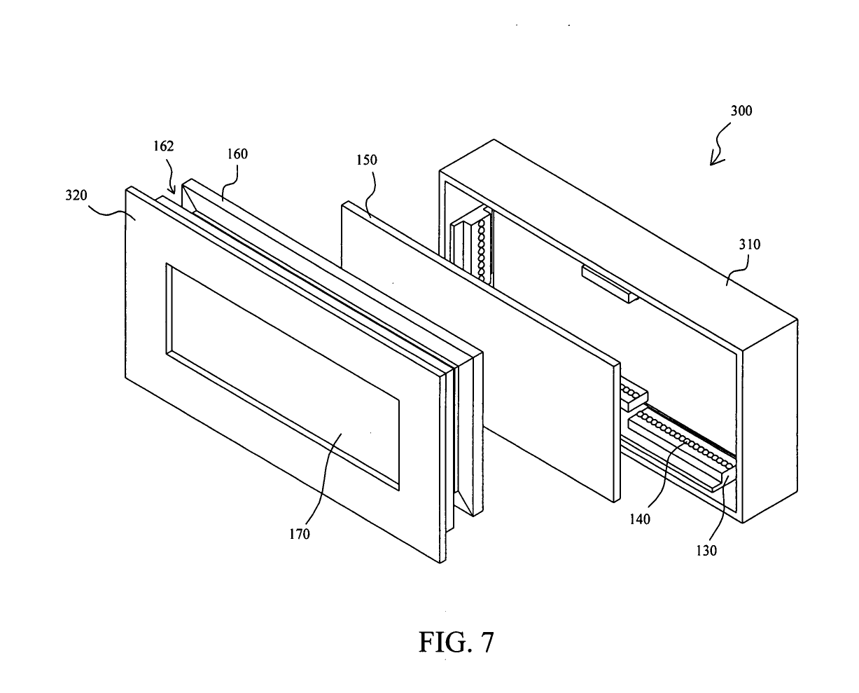

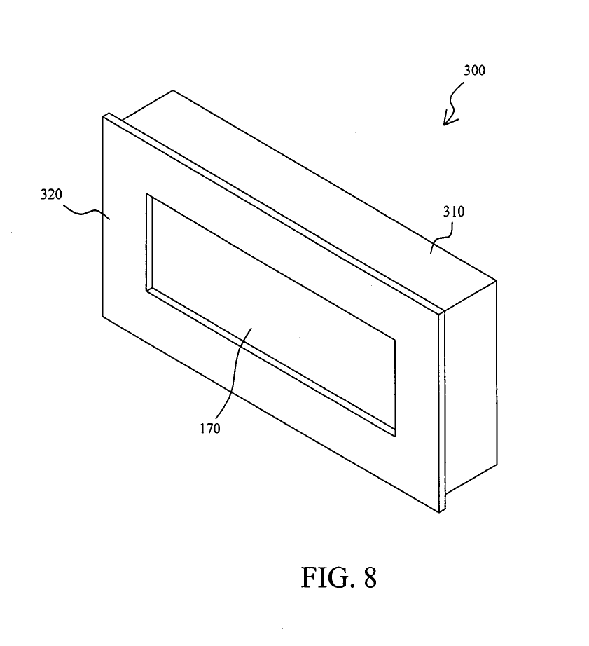

FIGS. 7 and 8 show a decomposition diagram and a combination diagram of a third embodiment according to the present invention. A signboard 300 comprises a part 310 having bases 130 each at one side to mount the LED lamps 140 and the reflector 150 inside thereof, and another part 320 having the light guide plate 160 and the panel 170 mounted thereon. The parts 310 and 320 could be combined together, for example by lodging the part 320 to the part 310. For maintenance or replacement of the elements in the signboard 300, the part 320 is pulled out from the part 310 to expose the elements in the signboard 300. If the module LED lamps 144, 147 or 148 are used for the LED lamps 140, replacing the LED lamps 140 is to remove the original module and plug a new module in the base 130.

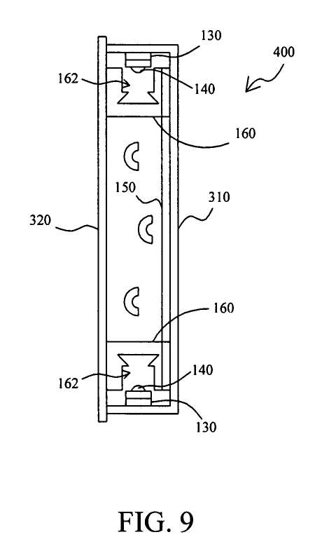

FIG. 9 shows a cross-sectional view of a forth embodiment according to the present invention. To be a signboard 400, the signboard 300 of FIG. 7 is introduced with several scattering plates 180 additionally behind the panel 170. Preferably, the scattering plates 180 are interlaced in positions to each other to increase the light scattered to the panel 170. The scattering plate 180 preferably has a curved surface or a wavy surface, and has its two ends fixed on the frame 310.

The signboard of the present invention uses LED lamps as its light source, and therefore has the advantages of low power consumption, long lifetime, compact volume, thin size, light weight and low failure rate. By arranging the LED lamps at the sides of the frame, the illumination on the panel is high and uniform. The reversible part or the removable part of the frame makes it easy to repair and to replace the LED lamps. The module LED lamps are easy to mount and replace. The light guide is small in volume and has a high light efficiency, and the scattering plate further increases the light efficiency.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A signboard using LED light source, comprising:
a frame having a front side mounted with a panel thereon;
a reflector behind the panel with a distance therebetween;
a plurality of LED lamps arranged at one side of the frame for providing a light to illustrate the panel; and
a light guide plate close to the plurality of LED lamps for guiding the light from the LED lamps to the panel and the reflector.

2. The signboard according to claim 1, wherein the frame includes as least one reversible part for exposing the plurality of LED lamps.

3. The signboard according to claim 1, wherein the frame includes at least one movable part for exposing the plurality of LED lamps.

4. The signboard according to claim 1, wherein the frame includes a first part and a second part combined together to have the panel and the light guide plate on the first part and the plurality of LED lamps on the second part.

5. The signboard according to claim 1, wherein the plurality of LED lamps are packaged in a module with at least two pins extending therefrom.

6. The signboard according to claim 1, wherein the plurality of LED lamps are individually mounted on a printed circuit board.

7. The signboard according to claim 1, wherein the light guide plate includes a groove aligned to the plurality of LED lamps.

8. The signboard according to claim 1, further comprising a diffusion plate between the light guide plate and the plurality of LED lamps.

9. The signboard according to claim 1, further comprising at least one scattering plate behind the panel.
